(19) United States
(12) Patent Application Publication
(10) Pub. No.: US 2006/0244716 A1
(43) Pub. Date: Nov. 2, 2006

(54) Theme display device

(76) Inventor: John R. Adams, Bridgewater, NJ (US)

Correspondence Address: Kenneth P. Glynn, 24 Mine Street, Flemington, NJ, 08822, US

(21) Appl. No.: 11/115,930

(22) Filed: Apr. 27, 2005

(51) Int. Cl. G09G 3/34

(52) U.S. Cl. 345/111

(57) ABSTRACT

A theme display device for representing a holiday, religion, religious holy day, memorial or other occasion, includes a window box having a predominantly open front divided into a viewable portion and a hidden portion form a front viewing perspective. Lighting is located in the hidden portion of the housing, directed into the viewable portion to illuminate it. A theme backdrop presentation is located on a front-facing surface of the back of the window box, and a theme icon component is positioned within the viewable portion of the box and forward from the back a predetermined distance, and a theme icon component support extends from behind the icon to the back so as to be hidden when the theme icon component is viewed from the front.

### BACKGROUND OF THE INVENTION

1. Field of the Invention

The present invention relates to a theme display device that is directed primarily to religious and holiday displays. It features an icon that appears from its front to be suspended in space. Illumination from one or more hidden light sources acts to accentuate the appearance of suspension. The present invention devices may be used for holyday themes or other religious purposes, for holiday displays, for memorials or for patriotic, organization or club symbol display.

2. Information Disclosure Statement

The following patents relate to display devices:

U.S. Pat. No. 2,298,940 to H. W. Hayes describes a display device of the class described, comprising, in combination, a substantially translucent sheet of material having integrally formed therewith a plurality of colored translucent portions, and a design carried by the colored translucent portions comprising a colored translucent main body portion formed by the integral colored translucent portions, a colored translucent marginal area overlying part of the main body portion of the design, and a substantially opaque final ground extending about the design.

U.S. Pat. No. 3,666,936 to Ranson W. Webster, Jr. et al. describes an enclosure having a translucent screen at the front thereof, a plastic screen having a pattern thereon parallel to and spaced from the translucent screen, and colored light bulbs arranged on the inside surface of the rear of the enclosure for blinking various colored patterns onto the translucent screen.

U.S. Pat. No. 4,163,333 to Joseph Kwiatkowski describes a candle box having a solid bottom and back and further including side panels having openings to permit insertion of a candle and to admit air and light therein. A front panel having a transparent member with designs imprinted thereon completes the enclosure. A reflective surface mounted to the back member behind the transparent member reflects a candle placed within the box as well as reflecting the design imprinted upon the transparent front member and light admitted from the sides and top. The candle, the design and reflection can all be seen

U.S. Pat. No. 5,037,679 to John T. Noble, Jr. et al. describes a decorative display device that has a frame member, a first scenic member contained within the frame, and a second member spaced from the first member by spacer means. One or more apertures in the first scenic member permit viewing the second member. A floor plate is affixed to the front of the scenic member and extends outwardly therefrom.

U.S. Pat. No. 5,264,995 to Joan B. McKee describes a non-electric candle lamp generally comprising a base member defining an upper surface including a recess and an elongate slot formed therein. Releasably engaged to the upper surface of the base member is a diffuser member which defines front and back surfaces and a lower edge portion which is receivable into the slot. Received into the recess of the base member is a candle sup including a candle disposed therein. The slot is formed in the upper surface of the base member in a manner wherein the diffuser member is angled toward the candle cup when the lower edge portion is received into the slot.

U.S. Pat. No. 5,411,780 to Pamela A. Kaefer describes a series of stained glass modules and connectors that allow arbitrary decorative apparatus assembles to be formed. The apparatus may be connected to any structure capable of supporting the weight of the assembled modules. Connectors are formed of a strong pliable material shaped in a decorative manner. Some connectors are permanently attached to decorative modules allowing the addition of other modules. Arrays of interconnected modules may be hung in openings or adjacent to windows, simulating a traditional stained glass assembly.

U.S. Pat. No. 5,554,420 to John T. Noble, Jr. describes a kit for assembly into a display device that has first and second plates adapted to be mounted and fixed in spaced relationship to each other. Each of the plates has a transverse slot therein which slots are aligned when the plates are in their fixed position. A floor member is adapted to be passed through the transverse slots and pins are provided for holding the floor member in place. A bracing member is adapted to bear against the under side of the floor plat and the front surface of the first plate.

U.S. Pat. No. 6,193,396 B1 to Timothy M. Winger et al. describes an apparatus that is a holder to mount decorations or an electric candle either inside or outside a window. A main shelf structure has extensions from both its horizontal surface and an attached vertical back section. The extensions from the vertical back sections angle back to the rear and then rise vertically again, and the uppermost vertical extensions have suctions cups to attach the entire structure to an adjacent window. An extension from the front edge of the horizontal main shelf angles downward, and the main shelf and the front angled extension have several holes with which to attach decorations, such as evergreen branches, in front of a vertically extending decoration such as a candle. The vertically extending decoration is mounted in “V” cuts within holding shelves which are attached to the vertical back section.

U.S. Pat. No. 6,793,365 B1 to Jane S. Rieck describes a window display in which illumination from a candlestick lines shines through an openings in a frame selected in correlation with a decorative display in providing an illumination presentation consistent with a holiday season of the year, or a secular or religious event or occasion in accordance with user preference, and of a composition and configuration to be detachable for folding flat for storage.

Notwithstanding the prior art, the present invention is neither taught nor rendered obvious thereby.

### SUMMARY OF THE INVENTION

A theme display device for representing a holiday, religion, religious holy day, memorial or other occasion, includes:

(a) a window box housing having a back, a top, a bottom and sidewalls, and having a predominantly open front, and being divided into a viewable portion and a hidden portion form a front viewing perspective;

(b) lighting means located in the hidden portion of the housing, the lighting means being directed into the viewable portion to illuminate at least a portion thereof;

(c) a theme backdrop presentation located on a front-facing surface of the back of the housing;

(d) a theme icon component positioned within the viewable portion between the top and the bottom of the housing and forward from the back a predetermined distance; and,

(e) a theme icon component support means extending from behind the icon to the back and positioned so as to be hidden when the theme icon component is viewed from the front.

The present invention theme display device preferably also includes a power sourcing means connected to the light, the power sourcing means being selected from the group consisting of AC wire and plug, DC wire and plug, battery power system, solar power system and combinations thereof.

In some preferred embodiments, the present invention theme display device further includes a light reflector at least partially surrounding the light to enhance projection of light from the hidden portion of the housing to the viewable portion and onto the theme icon component.

In some preferred embodiments, the present invention theme display device theme icon component is a religious icon component representing a religion selected from the group consisting of Christianity, Judaism, Muslim, Hinduism and Buddhism. For example, the theme icon component may be a Bible, Crucifix, a Star of David, a Buddha, a Koran or other religious icon.

In some preferred embodiments, the present invention theme display device theme backdrop presentation may be selected from the group consisting of simulated stain glass, stain glass, a painting, a print and a fabric.

The present invention theme display device theme icon support means may be at least one rod and attachment means. The rod and attachment means may be one piece or a plurality of functionally connectable pieces. The attachment means is selected from the group consisting of weld, heat weld, screw, and nut and bolt arrangement. They may be separate from and connected to an extender, such as a rod, they may be elongated and act as both the rod and the attachment means.

The present invention theme display front of the housing includes a window frame. The window frame may be a window-molding frame. Additionally or alternatively, in some preferred embodiments, the present invention display device frame has an inside cut periphery (reverse silhouette) representing a theme selected from the group consisting of a church, a temple and a synagogue. In other preferred embodiments, the theme display device wherein the frame has an inside cut periphery representing a holiday theme selected from the group consisting of a flag, a pumpkin, a heart, a turkey and an egg. The theme display device housing may have a frontal presentation selected from the group consisting of square, rectangular, circular and oval.

The theme display device top of the housing may be arched, or it may be peaked, or it may have a flat shape or any other shape, especially to further emphasize the theme.

The theme display device wherein the theme icon component may be any desired theme, and, in addition to the religious themes described above, could be selected from the group consisting of a heart (Valentine's Day, Wedding Day, Anniversary), flower (Birthday, Valentine's Day, Wedding, etc.) egg (Easter), turkey (Thanksgiving) and pumpkin (Fall or Harvest). Alternatively, the theme icon component could be a flag selected from the group consisting of national flag, state flag, association flag, military flag and school flag.

The theme display device may have the hidden portion located in an area selected from the group consisting of a bottom area, a top area a side area or any combination thereof, e.g., both top and bottom area.

### BRIEF DESCRIPTION OF THE DRAWINGS

The present invention should be more fully understood when the specification herein is taken in conjunction with the drawings appended hereto wherein:

FIG. 1 shows a front view of one preferred embodiment present invention theme display device for the Christian religions;

FIG. 2 shows a side cut view of the present invention device shown in FIG. 1;

FIG. 3 shows a front view of another preferred embodiment present invention theme display device for Judaism;

FIG. 4 shows a side cut view of the present invention device shown in FIG. 3;

FIG. 5 shows a front view of another preferred embodiment present invention theme display device for a Spring tulip celebration, which could be secular or could have religious messages and be a religious Easter display, or have a memorial message to make it a memorial, e.g., of a death;

FIG. 6 shows a side cut view of the present invention device shown in FIG. 5;

FIG. 7 shows a front view of another preferred embodiment present invention theme display device for Valentine's Day, a Wedding, an Anniversary or the like, depending upon the message;

FIG. 8 illustrates a front view of a present invention device with a Halloween theme; and,

FIG. 9 and FIG. 10 set forth charts of various present invention alternative theme presentations for the window frame silhouette, and for the “floating” icon, respectively.

### DETAILED DESCRIPTION OF THE PRESENT INVENTION

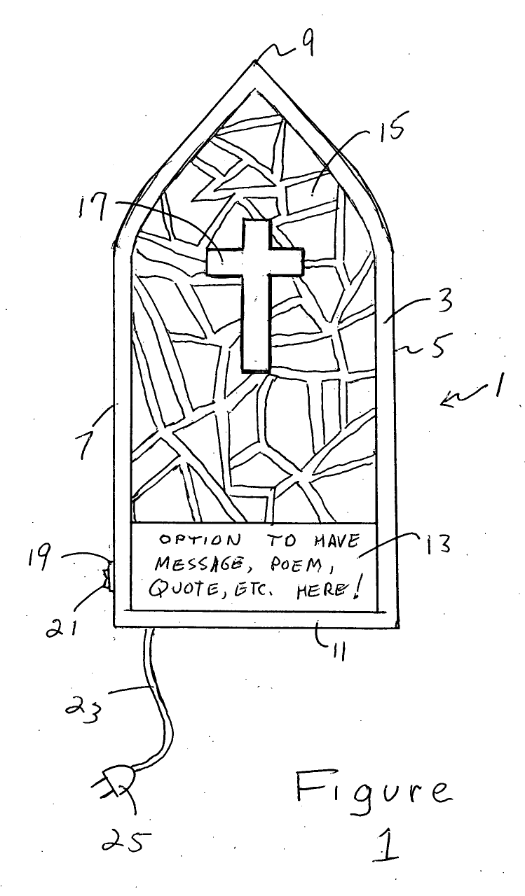

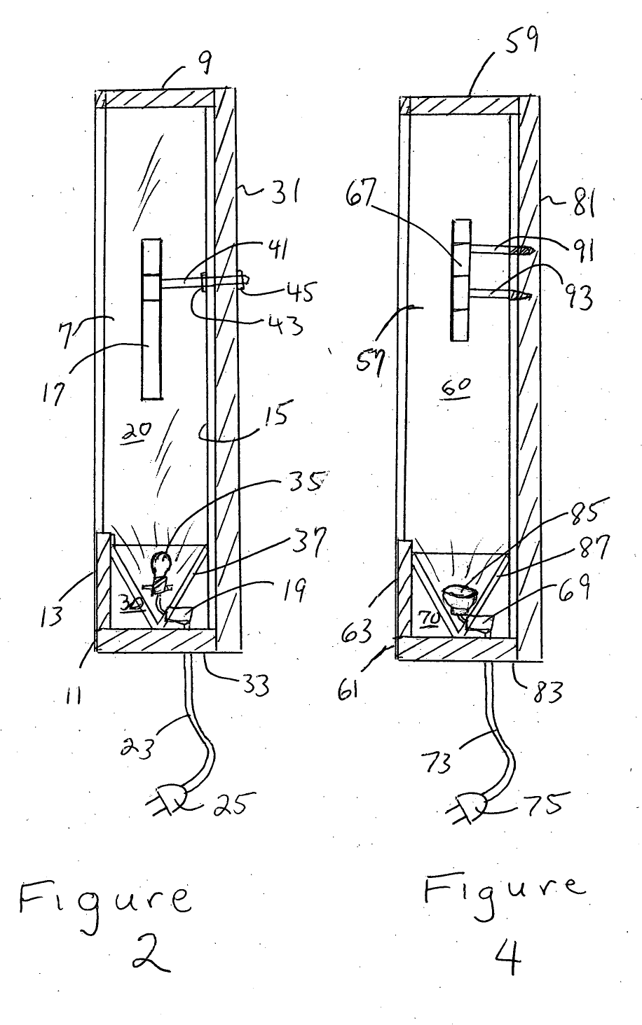

FIG. 1 shows a front view of one preferred embodiment present invention theme display device 1 for the Christian religions, such as Catholic and Protestant sects. FIG. 2 shows a side cut view of the present invention device 1 shown in FIG. 1. Both Figures will be described collectively.

This device 1 includes a window box with frame 3, opposing sidewalls 5 and 7, top 9, bottom frame 11, bottom 33, and back 31. It includes within the device 1, a predominantly open front, with a frontally viewable portion 20 and a frontally hidden portion 30. The viewable portion is to be seen from the front and contains what appears to be a floating theme icon component, in this case, crucifix 17, with a backdrop behind it. In this device 1, the backdrop is attached to the front surface of the back wall 33, although it could be painted on or otherwise as described above.

In this case, backdrop 15 is a simulated or real stained glass component. As shown in FIG. 1, it includes pieces of stained glass and lead network, or simulated, such as colored opaque plastic with network painted. One preferred embodiment includes clear, colored panels with reflective foil behind the panels. Other arrangements should now be within the purview of the artisan and encompassed within the scope of the present invention.

Crucifix 17 is held in place to appear floating by a frontal view hidden support, here, elongated threaded rod 41 and nuts 43 and 45. Lower front section 13 acts as an optional but desired message board and may contain messages, poems, quotes, memorials, or any other massage that the user may desire. The message may be permanent, erasable or removable, for example, slide tracks may be included and interchangeable messages may be used.

Hidden portion 30 contains a light fixture and bulb 35, with a junction box 19 and on/off switch 21. The switch and wiring could be arranged as desired, and the lighting could alternatively be remotely controlled with a wireless controller instead of a wired switch. In this embodiment there is also a preferred reflector 37 to direct the light toward the icon and backdrop. When viewed at night, this lighted presentation gives a floating in air look to the icon and is an attractive and inspiring display.

There is an electric cord 23 with plug 25 for powering the light. Alternatively, lighting could be solar powered with battery, battery, fuel cell or any other powering means without exceeding the scope of the present invention.

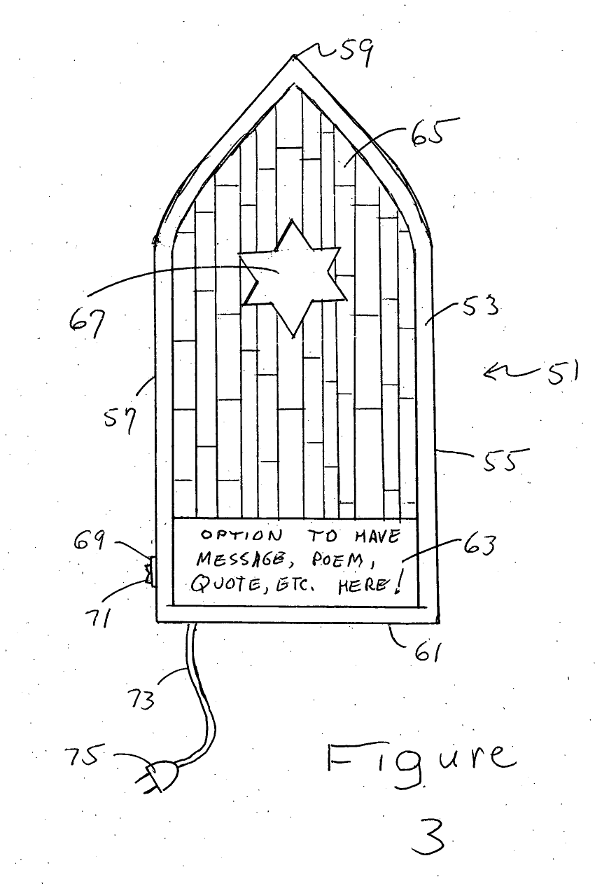

FIG. 3 shows a front view of another preferred embodiment present invention theme display device 51 for Judaism, and FIG. 4 shows a side cut view of the present invention device shown in FIG. 3. Both Figures will be described collectively.

Device 51 includes a window box with frame 53, similar to that shown in conjunction with the previous Figures. It has opposing sidewalls 55 and 57, top 59, bottom frame 61, back 81 and bottom 83. It has a predominantly open front, with a frontally viewable portion 60 and a frontally hidden portion 70. The viewable portion 60 contains what appears to be a floating Star of David 67 with a vertical stained glass backdrop behind it. The backdrop is attached to the front surface of the back wall 83

Star of David 67 is held in place to appear floating by two frontal view hidden supports 91 and 93, here, elongated large screws placed in drilled holes and glued and painted at the Star of David.

Lower front section 63 acts as an optional but desired message board and may contain messages, poems, quotes, memorials, or any other message such as the user desires. Other features such as described in conjunction with the prior Figures could likewise be utilized here.

Hidden portion 70 contains a spotlight fixture and spotlight bulb 85, with an outside switch box 69 and on/off switch 71. In this embodiment there is also a preferred reflector 87 to direct the light toward the icon and backdrop. There is also an electric cord 73 and plug 75 for light powering.

When viewed at night, this lighted presentation gives a floating in air look to the icon and is an attractive and inspiring display for the Jewish religion.

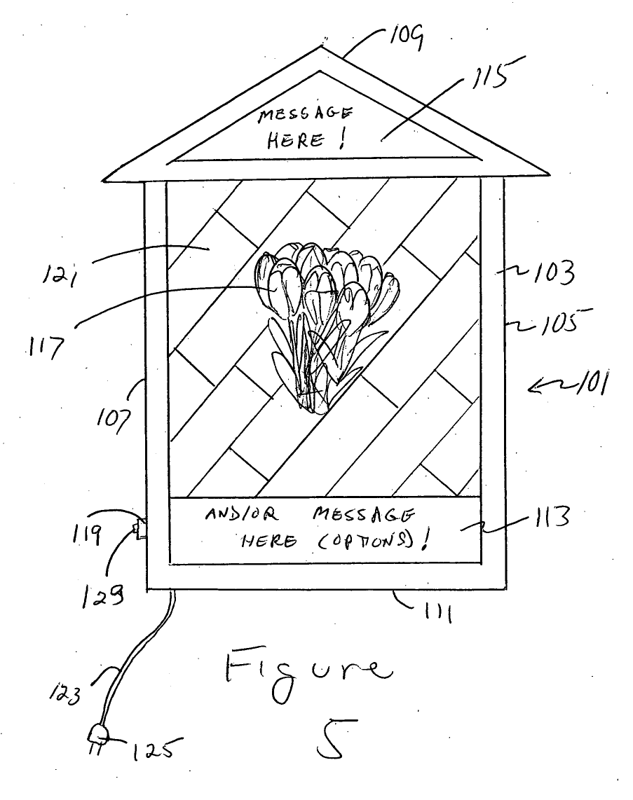

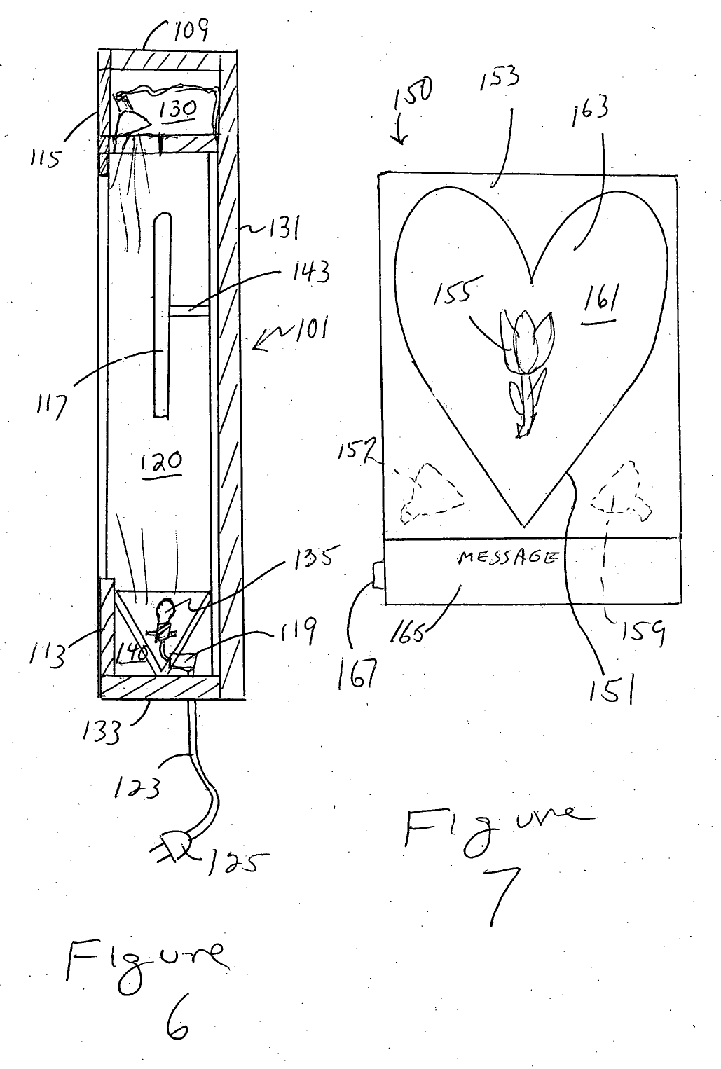

FIG. 5 shows a front view of another preferred embodiment present invention theme display device 101 for a Spring tulip celebration, which could be secular or could have religious messages and be a religious Easter display, or have a memorial message to make it a memorial, e.g., of a death. FIG. 6 shows a side cut view of the present invention device 101 shown in FIG. 5. Both Figures are described collectively.

Device 101 includes a window box with frame 103, with a peaked cap top 109. It also has opposing sidewalls 105 and 107, bottom 111 and back 131. It has a predominantly open front, with a frontally viewable portion 120 a frontally hidden upper portion 130 and a frontally hidden lower portion 140. A frame that is rectangular, as shown, surrounds the predominantly open front. The viewable portion 120 contains what appears to be a floating bouquet of tulips 117 against a diagonal shingled or other decorative backdrop 121. The backdrop is painted on the front surface of the back 131.

The tulip 117 is held in place to appear floating by a single drilled and glued dowel arrangement with dowel 143

Lower front section 113 and/or upper front section 115 may act as an optional but desired message boards and may contain any message(s) that the user desires. Other features such as described in conjunction with the prior Figures could likewise be utilized here.

Hidden portions 130 and 140 each contain a light fixture and bulb, such as light bulb 135. There is an outside switch box 119 and on/off switch 129. In this embodiment, there is a bottom hidden portion 140 reflector to direct the light toward the icon and backdrop, and the top hidden portion 130 has a cut out for light projection, as shown. There is also an electric cord 123 and plug 125 for light powering.

FIG. 7 shows a front view of another preferred embodiment present invention theme display device 150 for Valentine's Day, a Wedding, an Anniversary or the like, depending upon the message in message box 165. A personal poem or chosen expression may be used, such as:

“Tis not the scent

The beauty

Nor

The velvety petals

Tis the love

Silent

Invisible

And true!”

Love, -John

The construction of the device is similar to those described, except that a specific silhouette in the shape of a heart 151 cut out of a larger frame 153 has been created. Backdrop 163 is a velvety high gloss white linen, and the icon is a brilliant red rose 155. Viewable space 163, the backdrop 163 and the rose 155 are illuminated from the bottom hidden portion by light(s) not shown, controlled by batteries and switch 167. This is an extremely vivid presentation when lighted at night or in a darkened area.

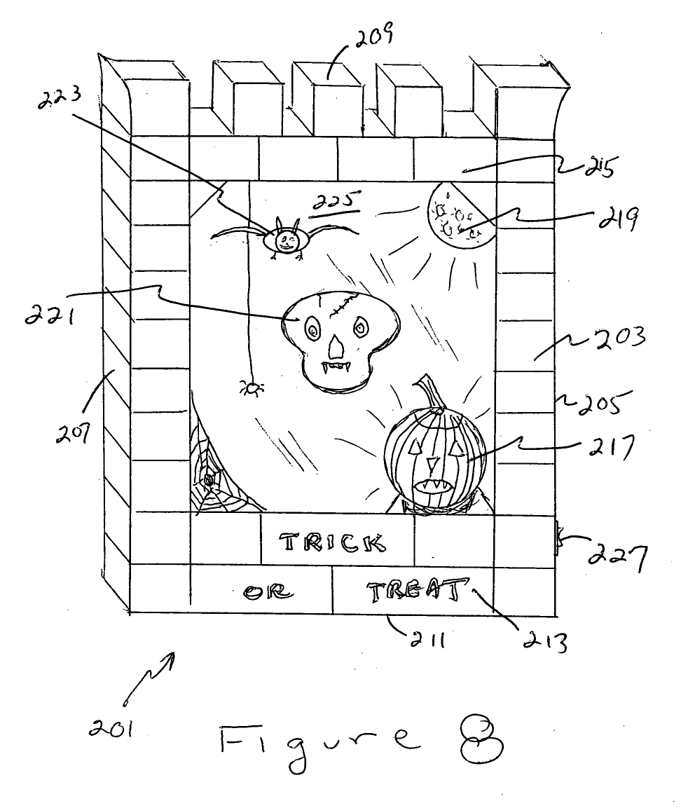

FIG. 8 shows a front view of a present invention theme display device 201 for Halloween. It has a window box frame 203 with castle design, and with sidewalls 205 and 207, top 209 and bottom 211. Lower area 213 includes the “Trick Or Treat” message and both the lower area 213 and the upper area 215 contain wiring, lighting fixtures, etc. with bulbs located behind pumpkin 217 and moon 219. Both lights are hidden and project onto skull 221. Bat 223 and skull 221 appear “suspended” and have back projecting supports hidden and connected to back wall 225. There is a control switch 227. The device 201 could be battery powered, as in the Figure, or have solar or solar/battery or house current cord and plug, as a manufacturer may elect.

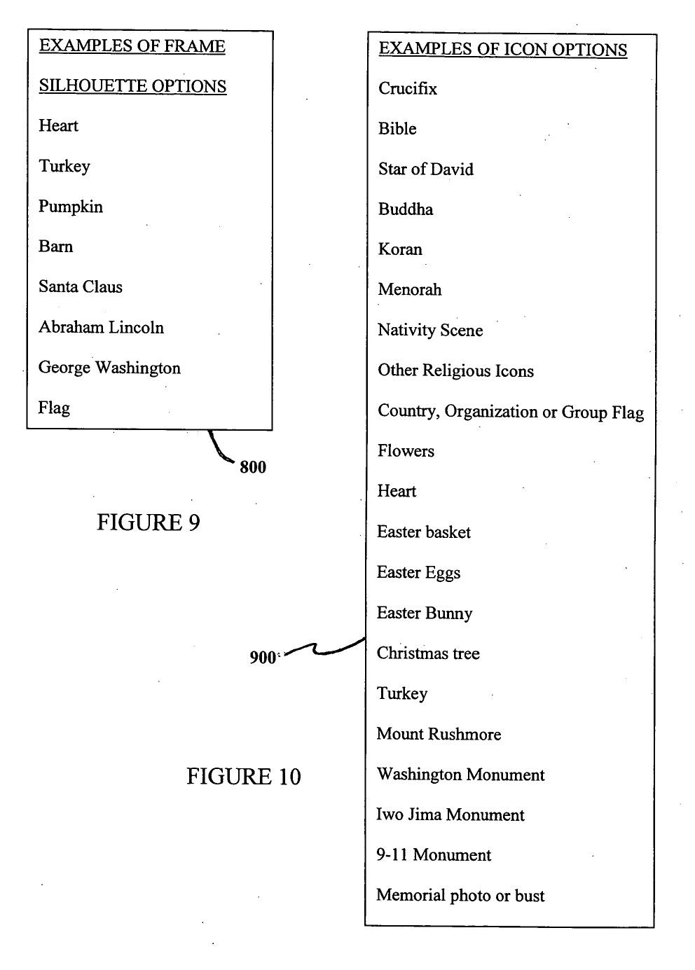

FIG. 9 and FIG. 10 set forth charts of various present invention alternative theme presentations for the window frame silhouette, and for the “floating” icon, respectively.

FIG. 9 Examples of Frame Silhouette Options

Heart

Turkey

Pumpkin

Barn

Santa Claus

Abraham Lincoln

George Washington

Flag

Tree

FIG. 10 Examples of Icon Options

Crucifix

Bible

Star of David

Buddha

Koran

Menorah

Nativity Scene

Other Religious Icons

Country, Organization or Group Flag

Flowers

Heart

Easter basket

Easter Eggs

Easter Bunny

Christmas tree

Turkey

Mount Rushmore

Washington Monument

Iwo Jima Monument

9-11 Monument

Memorial photo or bust

Obviously, numerous modifications and variations of the present invention are possible in light of the above teachings. For example, the lighting system for the present invention devices may include one or more prisms to create an array of different colored illuminations. It is therefore understood that within the scope of the appended claims, the invention may be practiced otherwise than as specifically described herein.

1-3. (canceled)

4. A method for a workload based completion indication request mechanism, comprising:
determining a dynamic workload;
updating a completion indication request rate based on the dynamic workload; and
sending a completion indication request, according to the completion indication request rate, to request a completion indication.

5. The method according to claim 4, wherein said determining the workload includes determining the workload based on at least some of:
system metric;
device metric; or
bus utilization metric.

6. The method according to claim 5, wherein the completion indication request rate is expressed as at least some of:
a frequency representing the frequency at which a completion indication request is sent;
a periodicity representing the time interval at which a completion indication request is sent; and
an integer representing number of packets between two consecutive completion indication requests.

7. A method for a completion indication request rate determiner, comprising:
receiving information related to workload;
updating current completion indication request rate based on the information related to a workload to generate an updated completion indication request rate.

8. The method according to claim 7, wherein said updating comprises at least one of:
revising the current completion indication request rate according to some some criteria based on the workload; or
replacing the current completion indication request rate using a new completion indication request rate computed based on the workload.

9. The method according to claim 8, wherein said revising the current completion indication request rate comprises:
setting the current completion indication request rate as per operation if the workload is low;
decreasing the current completion indication request rate if the workload is high; and
increasing the current completion indication request rate is the workload is between low and high.

10-14. (canceled)

15. A workload based completion indication request mechanism connecting to a device driver, comprising:
a workload determiner for dynamically determining a workload;
an indication request rate determiner for determining a completion indication request rate based on the workload; and
a completion indication request mechanism for sending a completion indication request to a controller according to the completion indication request rate.

16. The system according to claim 15, wherein the workload determiner determines the workload of at least one of
the device driver;
a controller that performs tasks assigned by the device driver; and
a bus connecting the device driver and the controller.

17-20. (canceled)

21. A machine-accessible medium encoded with data for a workload based completion indication request mechanism, the data, when accessed, causing:
determining a dynamic workload;
updating a completion indication request rate based on the dynamic workload; and
sending a completion indication request, according to the completion indication request rate, to request a completion indication.

22. The medium according to claim 21, wherein said determining the workload includes determining the workload based on at least some of:
number of transactions per unit time on a bus;
a utilization percentage of the bus;
number of packets transmitted per unit time; or
number of bytes transmitted per unit time.

23. The medium according to claim 22, wherein the completion indication request rate is expressed as at least one of:
a frequency representing the frequency at which a completion indication request is sent;
a periodicity representing the time interval at which a completion indication request is sent; and
an integer representing number of packets between two consecutive completion indication requests.

24. A machine-accessible medium encoded with data for a completion indication request rate determiner, the data, when accessed, causing:
receiving information related to workload;
updating current completion indication request rate based on the information related to a workload to generate an updated completion indication request rate.

25. The medium according to claim 24, wherein said updating comprises at least one of:
revising the current completion indication request rate according to some some criteria based on the workload; or
replacing the current completion indication request rate using a new completion indication request rate computed based on the workload.

26. The medium according to claim 25, wherein said revising the current completion indication rquest rate comprises:
setting the current completion indication request rate as per operation if the workload is low;
decreasing the current completion indication request rate if the workload is high; and
increasing the current completion indication request rate is the workload is between low and high.

27-28. (canceled)
